(19) United States
(12) Patent Application Publication
(10) Pub. No.: US 2025/0289024 A1
(43) Pub. Date: Sep. 18, 2025

(54) HOPPER AND POWDER SUPPLY APPARATUS INCLUDING THE SAME

(71) Applicant: LG ELECTRONICS INC., Seoul (KR)

(72) Inventors: Jaemoon JOO, Seoul (KR); Yujin LEE, Seoul (KR); Yoonhyun KIM, Seoul (KR); Yoomin EOM, Seoul (KR)

(73) Assignee: LG ELECTRONICS INC., Seoul (KR)

(21) Appl. No.: 19/068,502

(22) Filed: Mar. 3, 2025

(30) Foreign Application Priority Data
Mar. 15, 2024 (KR) 10-2024-0036513
Feb. 14, 2025 (WO) PCT/KR2025/099382

(51) Int. Cl. B05C 19/06; B05C 19/00

(52) U.S. Cl. CPC B05C 19/06; B05C 19/008

(57) ABSTRACT

Disclosed are a hopper for storing and discharging powder and a powder supply apparatus including the same. The hopper includes a body having a hollow structure that is open at the top and bottom and an inclined passage connected to a lower end of the body, the inclined passage being configured to gradually narrow downward. The body includes a reverse-inclined portion having a structure that gradually widens toward a lower end, enabling smooth discharge of the powder.

### CROSS-REFERENCE TO RELATED APPLICATIONS

Pursuant to 35 U.S.C. § 119, this application claims the benefit of earlier filing date and right of priority to Korean Patent Application No. 10-2024-0036513 filed on Mar. 15, 2024, and International Application No. PCT/KR2025/099382, filed on Feb. 14, 2025, the contents of which are all hereby incorporated by reference herein in their entireties.

### BACKGROUND

### Field

The present disclosure relates to a hopper and a powder supply apparatus, and more particularly to a hopper and a powder supply apparatus having a structure in which powder is supplied uniformly from a discharge port extending in one direction.

### Discussion of the Related Art

Secondary batteries, which can be repeatedly charged and discharged, are used in a variety of electronic devices. In particular, a lithium-ion secondary battery is widely used due to high energy density and long lifespan. In a process of manufacturing secondary batteries, a negative electrode active material, a positive electrode active material, and a separator configured to separate the negative and positive electrode materials from each other are included as the main components. In order to manufacture each of the negative and positive electrode materials, raw materials are mixed to form a slurry, which is coated, dried, and roll-pressed into a final electrode.

In particular, an electrode active material, a conductive agent, and binder must be uniformly mixed in order to form the slurry, and accuracy of a mixing process has a significant impact on the quality of a product. At this time, a hopper, which is a facility that supplies raw materials to the mixer, is used.

The hopper is an apparatus used to store or discharge materials such as powder, grain, and concrete, and generally has the shape of a funnel. A general hopper is designed so as to gradually narrow toward a discharge port in order to induce the movement of the powder downward by gravity, but this structure may cause accumulation and flow delay of the powder due to friction between the inner wall and the powder.

In particular, when a large amount of powder is stored, the frictional force with the inner wall acts asymmetrically, reducing discharge speed and uniformity. This uneven flow not only reduces the discharge speed of the powder but also hinders the production of a homogeneous slurry, which may lead to a deterioration in the quality of a final electrode.

Moreover, in the process of concentrating the powder to the discharge port, the internal frictional force may act asymmetrically, which may distort the discharge direction or block the flow.

In order to solve this, some conventional designs further adopt a mixer including an impeller to forcefully mix or discharge the powder, but this increases the complexity of the facility and requires additional power, which reduces economic feasibility and ease of maintenance.

As a result, conventional hopper designs have difficulty ensuring the uniformity and stability of powder discharge required in precision processes such as a secondary battery manufacturing process. In order to solve this, a new design capable of solving the frictional force problem and keeping the discharge flow uniform is required.

### SUMMARY

The present disclosure is to address at least the above-mentioned problems and/or disadvantages and to provide at least the advantages described below. Accordingly, an object of the present disclosure is to provide a structure in which powder is discharged uniformly from a discharge port of a hopper.

Another object of the present disclosure is to provide a hopper capable of effectively preventing external leakage of powder during a powder discharge process.

A further object of the present disclosure is to provide a hopper capable of efficiently dispersing the frictional force between the powder and the hopper to maintain a smooth flow.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

A hopper according to an embodiment of the present disclosure includes a body having a hollow structure that is open at the top and bottom, the body being configured to store powder, and an inclined passage connected to a lower end of the body, the inclined passage extending so as to gradually narrow downward, wherein the body includes a reverse-inclined portion having a structure that gradually widens toward a lower end.

The body may further include a straight portion, and the straight portion may be connected to an upper end of the reverse-inclined portion, the straight portion extending upward.

The reverse-inclined portion may include at least one inner surface perpendicular to the ground.

The hopper may further include a separation plate located in the body so as to be perpendicular to the ground, the separation plate being configured to partition the interior of the body.

The body may include a guide recess formed in a side surface thereof, the guide recess being configured to allow the separator plate to be mounted therein.

At least a part of a side of the separation plate substantially perpendicular to the ground may be spaced apart from an inner surface of the body.

The separating plate may be made of a material that does not react with the powder.

The body may include an air inlet formed in an outer surface thereof, the air inlet being configured to allow compressed air to be supplied from an outside therethrough.

The hopper may further include an air slit located at a side surface of the inclined passage, the air slit being connected to the air inlet, the air slit being configured to allow the supplied compressed air to pass therethrough in a direction toward the ground.

A powder supply apparatus according to another embodiment of the present disclosure includes the hopper and a calendering roller located under the hopper.

The side surface of the inclined passage may have a shape corresponding to a surface of the calendering roller.

### BRIEF DESCRIPTION OF THE DRAWINGS

The accompanying drawings, which are included to provide a further understanding of the present disclosure and are incorporated in and constitute a part of this application, show embodiment(s) of the present disclosure and together with the description serve to explain the principle of the present disclosure. In the drawings:

FIG. 1 is a view showing a powder supply apparatus according to an embodiment of the present disclosure;

FIG. 2 is a perspective view of a hopper according to an embodiment of the present disclosure;

FIG. 3 is a view showing a hopper including a separation plate according to an embodiment of the present disclosure;

FIG. 4 is a view showing a separation plate according to an embodiment of the present disclosure;

FIG. 5 is a longitudinal sectional view of the hopper according to the embodiment of the present disclosure;

FIG. 6 is an enlarged view showing part A of FIG. 5; and

FIG. 7 is a view showing the results of uniform discharge experiment of the hopper according to the embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Hereinafter, a hopper and a powder supply apparatus according to an embodiment of the present disclosure will be described in detail with reference to the drawings.

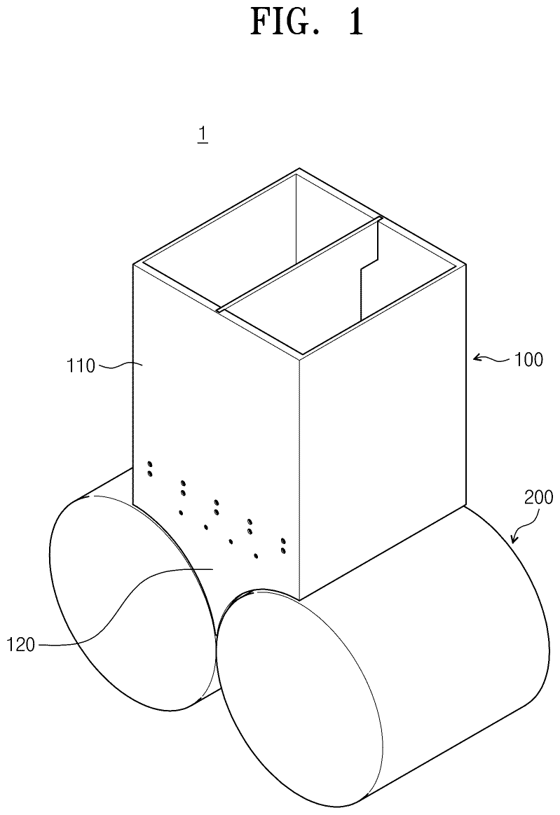

FIG. 1 is a view showing the general configuration of a powder supply apparatus 1 according to an embodiment of the present disclosure. The powder supply apparatus 1 may include a hopper 100 and a calendering roller 200.

The hopper 100 performs the function of storing powder and discharging the powder downward, and may include a body 110 and an inclined passage 120. The body 110 has a hollow structure that is open at the top and bottom and serves to store powder.

An upper part of the body is mainly used to introduce powder or mixed powder, and a lower part of the body may form a certain space in which powder is temporarily stored and from which the powder is discharged.

In the figure, the body 110 is shown as a square column, but the shape of the body 110 is not limited thereto, and the body may be formed in any of various shapes such as a circular column or a polygonal column.

The inclined passage 120 is connected to a lower end of the body 110 and may guide powder downward. Since the bottom of the body 110 is open, a side wall of the body 110 may extend to form the inclined passage 120.

The inclined passage 120 may have a shape that gradually narrows downward, and may be designed such that powder can be efficiently discharged by gravity.

In addition, as shown in FIG. 1, the inclined passage 120 may have a shape corresponding to the surface shape of the calendering roller 200 located under the hopper 100.

For example, as shown in FIG. 1, the inclined passage 120 may be configured in a curved shape corresponding to the surface curvature of the calendering roller 200 such that there is no empty space.

In addition, the inclined passage 120 has a structure corresponding to the shape of the roller 200, and may be implemented in a shape in which the entirety of a lower surface thereof is open or may be configured in a shape in which a discharge port is provided in the center thereof.

However, the edge of the inclined passage 120 and the calendering roller 200 may be spaced apart from each other by a certain distance so as not to be in contact with each other. This is to ensure that the rotation of the calendering roller 200 is smooth.

The calendering roller 200 may be an apparatus that rolls powder with strong shear force at high pressing temperature using a plurality of heated rollers. This allows an electrode material to be adjusted to a desired thickness and density, and the physical and chemical properties of the powder may be improved.

Calendering is a key step in a battery manufacturing process, and rollers may be used to press the electrode material more densely with high uniformity.

As shown in FIG. 1, the calendering roller 200 according to the embodiment of the present disclosure may be provided in one on each of both sides, and the calendering rollers may rotate in opposite directions to press the powder discharged from the hopper 100.

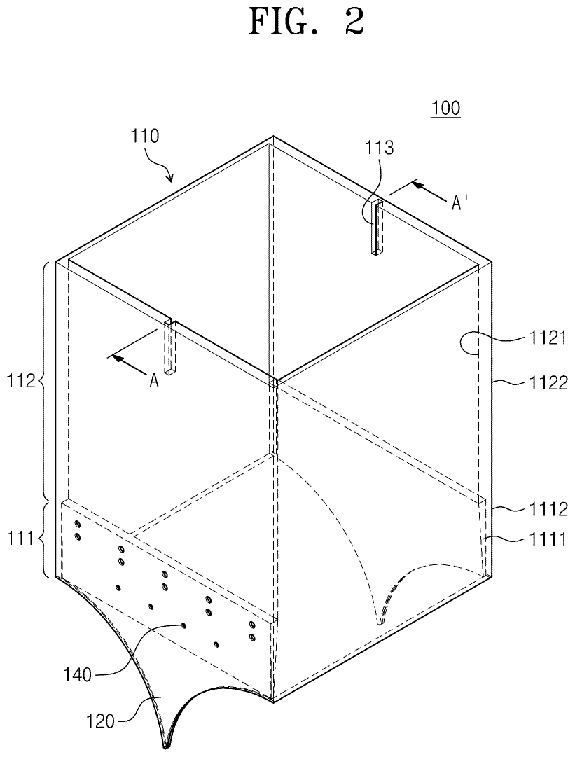

Hereinafter, the structure and features of a hopper 100 according to an embodiment of the present disclosure will be described in detail with reference to FIG. 2.

FIG. 2 is a perspective view of a hopper 100 according to an embodiment of the present disclosure.

As described above, the hopper 100 may include a body 110 and an inclined passage 120. The body 110 is formed in the shape of a container that is open at the top and bottom, and the inclined passage 120 may be connected to a lower end of the body 110 and may have a structure that gradually narrows downward.

For convenience of description, the configuration of the hopper 100 will be described based on a body 110 formed in the shape of a rectangular column shown in FIG. 2

That the inclined passage 120 gradually narrows downward may mean that the width of a side wall constituting the inclined passage gradually decreases or that the sectional area of the inclined passage gradually decreases. This may include a structure in which a lower end of the inclined passage 120 is completely open such that powder is directly discharged onto the roller 200 or a structure in which powder is discharged under control in a partially closed state.

The body 110 may include a straight portion 112 and a reverse-inclined portion 111. The reverse-inclined portion 111 refers to a part designed such that the internal sectional area of the body 110 gradually increases toward a lower end. Referring to FIG. 2, the straight portion 112 and the reverse-inclined portion 111 may include inner surfaces 1121 and 1111 and outer surfaces 1122 and 1112, respectively.

The straight portion 112 is a part that is not inclined, and may generally be perpendicular to the ground. The straight portion has a general container shape and may be used to store powder.

The reverse-inclined portion 111 is connected to a lower end of the straight portion 112, extends downward, and has a structure that gradually widens toward the lower end. In this embodiment, the straight portion 112 and the reverse-inclined portion 111 are connected to each other, but the body 110 may be constituted only by the reverse-inclined portion 111.

In the embodiment shown in FIG. 2, only the inner surface 1111 of the reverse-inclined portion 111 gradually widens downward, and the outer surface 1112 is formed vertically. However, the present disclosure is not limited thereto, and both the inner and outer surfaces may gradually widen toward the lower ends.

The reverse-inclined portion 111 may include a structure in which the inner surface of the reverse-inclined portion faces outward toward a lower end thereof and an upper part of the reverse-inclined portion is inclined inward. That is, the inner space of the reverse-inclined portion may gradually widen toward the lower end.

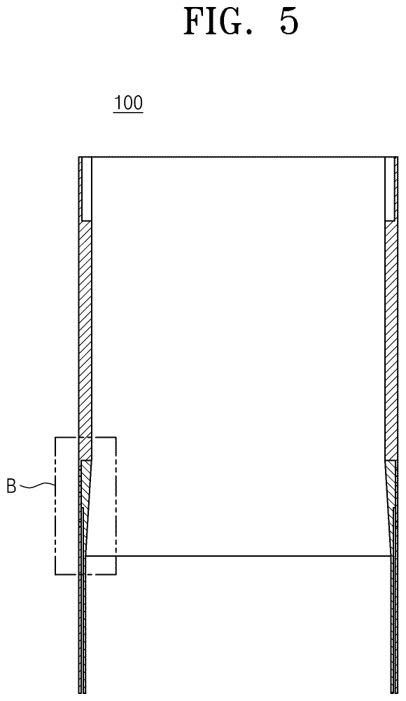

The inclined inner surface of the reverse-inclined portion 111 may be formed on at least one inner surface of the body, preferably on both side surfaces perpendicular to the axis of the roller 200. Referring to part B of FIG. 5, the section of the reverse-inclined portion 111 is shown. The reverse-inclined portion 111 is located under the straight portion 112 and may include a slope that gradually faces outward toward the lower end.

At this time, the angle (a) between the inner surface of the reverse-inclined portion 111 and the horizontal plane is an acute angle, preferably about 82°. A conventional hopper generally includes a funnel shape that gradually narrows downward, but the hopper 100 including the reverse-inclined portion 111 according to the embodiment of the present disclosure may reduce the frictional force between mixed powder and the inner wall through such a structure. As a result, it is possible to remedy the uneven flow of powder that may occur during a discharge process, thereby achieving uniform discharge.

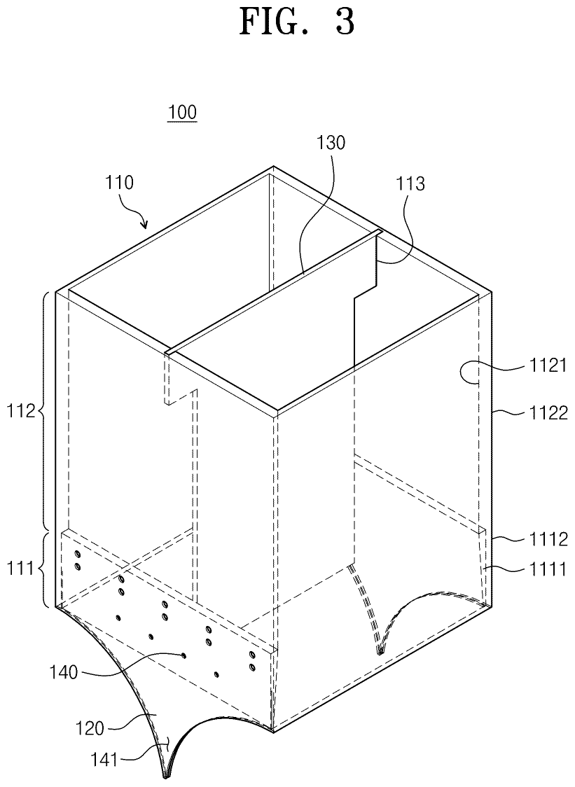

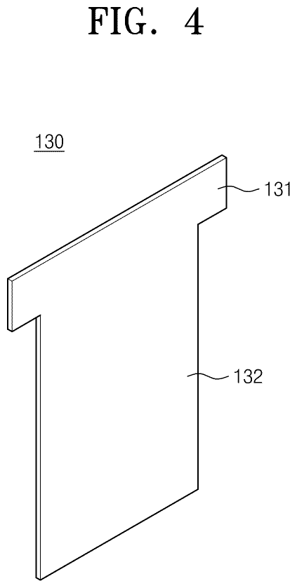

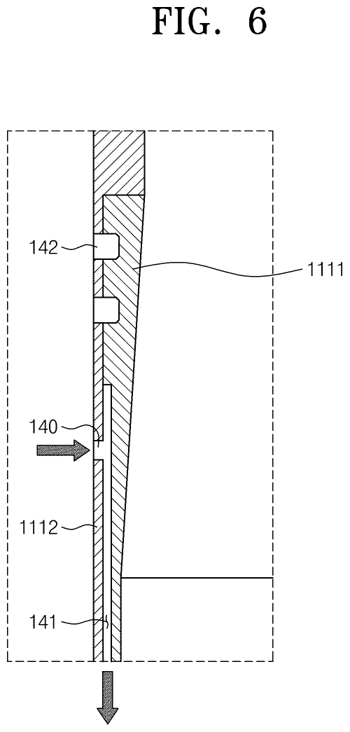

Meanwhile, the body 110 may further include a guide recess 113 for mounting a separation plate 130 and an air inlet 140. The guide recess 113 will be described later in relation to the separation plate 130 with reference to FIGS. 3 and 4, and the air inlet 140 will be described later with reference to FIGS. 5 and 6.

Hereinafter, a separation plate 130 according to an embodiment of the present disclosure will be described in detail with reference to FIGS. 3 and 4. FIG. 3 is a view showing a hopper 100 including a separation plate 130 according to an embodiment of the present disclosure, and FIG. 4 is a view showing the structure of the separation plate 130.

The separation plate 130 may be installed in the hopper 100 to control the flow of powder. The separation plate 130 may be formed in a structure that can divide the interior of the body 110 substantially perpendicular to the ground.

This allows the function of evenly distributing the frictional force between powder and the wall while the powder moves to the lower part of the hopper 100. If the separation plate 130 is not provided, the difference in frictional force between powder and the wall surface in the center and at the edge may cause an imbalance in the discharge speed and direction of the powder.

However, if the separation plate 130 is installed, frictional force is generated even in the center, resulting in an even distribution of friction throughout the entire structure, and this structural feature may contribute to maintaining a uniform flow and discharge of the powder.

The separation plate 130 may be fixed by the guide recess 113. The guide recess 113 is a recess formed in the inner surface of the body 110, and a part of the separation plate 130 is fitted into the guide recess such that separation plate can be stably located while being supported.

The guide recess 113 may be formed along the side of the separation plate 130 so as to have a certain length, which may effectively prevent the separation plate 130 from moving in the horizontal and vertical directions.

In addition, the shape of the guide recess 113 is not particularly restricted, and other fixing mechanisms, such as a clamp or a slot, may be used. For example, a magnetic fixing method using a magnet or a screw fastening method may be used. This allows the guide recess 113 to be optimized according to the structural design of the hopper 100 and the characteristics of powder.

Meanwhile, at least a part of the side of the separation plate 130 may be spaced apart from the inner surface of the body 110, which prevents excessive frictional force that may occur when the surfaces come into direct contact with each other and achieves optimal frictional force distribution.

If the separation plate 130 is spaced apart from the inner surface of the body 110 by a certain distance without contact therewith, the friction on a movement path of the powder may be evenly distributed, the flow of the powder may be smooth, and the uniformity of the discharge process may be improved. This design ensures that the powder is subjected to the same frictional resistance in the center and at the edge, thereby maintaining consistency in the discharge speed. Preferably, the separation plate is configured to cover 91% of the section of the body.

The shape of the separation plate 130 is not particularly restricted, and may be variously changed depending on the structure of the hopper 100 and the characteristics of the powder.

Referring to FIG. 4, the separation plate 130 may include a support portion 131 and a flat portion 132.

The support portion 131 may serve to fix the separation plate 130 to the guide recess 113 of the body 110, and the flat portion 132 may serve to control the flow of the powder and to appropriately distribute the frictional force. However, this configuration is merely an example, and only a part of the side surface of the separation plate 130 may be connected to the body 110 or the entirety of the separation plate may not be connected to the body.

For example, the separation plate 130 may be fixed only in the center to intensively adjust the flow of the powder in the upper part of the inclined passage 120, or may be deformed into a curved surface, a polygon, or a shape including an opening depending on the characteristics of the powder.

Also, in the embodiment shown in FIGS. 3 and 4, the separation plate 130 is flat, but the separation plate may have a polygonal shape, a curved shape, or a shape coupled thereto as needed. In this case, the flow of the powder in the hopper 100 may be optimized.

The direction in which the separation plate is fixed is not particularly restricted, and the separation plate may be installed at various positions and in various directions for optimal distribution of frictional force depending on the flow characteristics of the powder and the structure of the hopper.

For example, if the separation plate is disposed in the center of the area, the separation plate may induce a uniform flow of the powder, and if the separation plate is disposed at a side surface or an asymmetrical position, the separation plate may prevent the concentrated discharge of the powder by adjusting the frictional force on a specific path. Preferably, the separation plate is provided in a direction parallel to the axis of the roller.

Meanwhile, the separation plate 130 may be made of a material that does not react with the mixed powder. For example, the separation plate 130 may be made of a material that has high thermal conductivity, satisfies durability required in a secondary battery manufacturing process, and does not react with a secondary battery material.

Referring to FIG. 3, the separation plate 130 may contribute to evenly distributing and discharging the powder in the inclined passage 120 and the inner space of the body 110. A lower end of the separation plate 130 may be formed in close proximity to an upper part of the inclined passage 120, which may serve to control the distribution of the powder in the inclined passage 120 while the powder moves to the discharge port.

Hereinafter, an air slit according to an embodiment of the present disclosure will be described in detail with reference to FIGS. 3, 5, and 6. FIG. 5 is a longitudinal sectional view of the hopper according to the embodiment of the present disclosure, taken along line A-A′ of FIG. 2. FIG. 6 is an enlarged view showing part A of FIG. 5.

The hopper 100 according to the embodiment of the present disclosure may generate a so-called air curtain. The air curtain may serve to prevent external leakage of the powder that may occur when the powder passes through the discharge port (or the lower end of the inclined passage) and to keep the flow direction of the powder stable.

The air curtain is formed along the edge of the hopper, and may mainly form an airflow toward the ground. The air curtain may be generated along an outer surface of the hopper or formed in the internal space of the hopper.

According to the embodiment of the present disclosure, since there is a possibility that the powder may leak out due to the structure in which the hopper 100 and the roller 200 are spaced apart from each other by a certain distance, the powder is prevented from leaking out by forming the air curtain in the direction of discharge of the powder (that is, the direction toward the ground) by injecting compressed air (see the arrow in FIG. 6).

Referring to FIG. 3, the hopper according to the embodiment of the present disclosure may include an air inlet 140 and an air slit 141 configured to form the air curtain.

The air inlet 140 receives compressed air from the outside, and may be installed in the outer surface of the hopper 100 or in the upper part of the inclined passage 120. The figure shows that the air inlet is formed in the outer surface of the lower part of the body, but this is merely an example, and the air inlet may also be formed in the inclined passage and may be disposed at the optimal position to control the discharge direction and flow of the powder.

Referring to FIG. 6, the air inlet 140 may be connected to the air slit 141, which is located in the side surface of the inclined passage 120 to guide the supplied compressed air in the direction toward the ground (see the arrow in FIG. 6).

As shown in FIG. 6, an air slit 141 may be formed between the outer wall 1112 and the inner wall 1111, and may be appropriately disposed around the powder discharge port to form the air curtain. In addition, the air slit 141 may be attached to the outer surface of the hopper or may be coupled to the inner structure.

The air inlet 140 may be installed at various positions, such as the upper end, the middle, or the lower end of the inclined passage, and the position of the air inlet may be optimized according to the discharge characteristics of the powder and the need to form the air curtain.

For example, if the air inlet is located at the upper end of the inclined passage, the air curtain may be formed to stabilize the flow of the powder before the powder moves to the discharge port. On the other hand, if the air inlet is located in the middle or at the lower end, this may be effective in controlling the flow of the powder just before discharge.

The air curtain may be formed only at both side surfaces of the inclined passage or, if necessary, along all side surfaces of the inclined passage. This design may help prevent the external leakage of the powder, maintain uniform discharge, and provide flow stability during the discharge process.

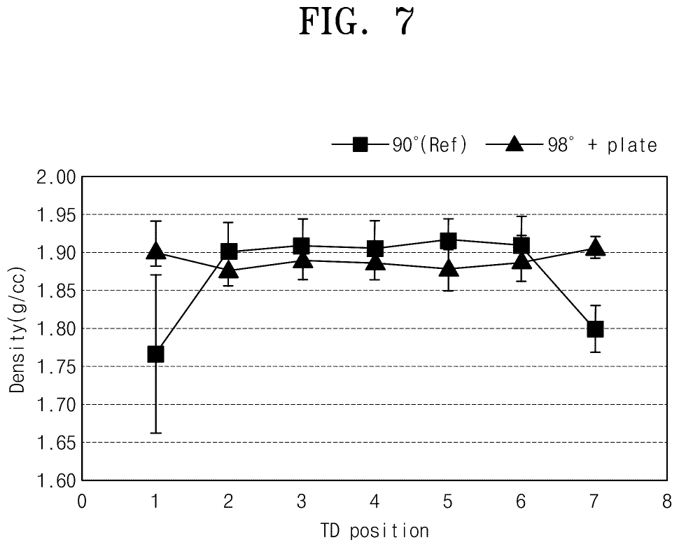

FIG. 7 is a view showing the results of uniform discharge experiment of the hopper according to the embodiment of the present disclosure. The results of evaluation of the uniformity of the flow that occurs when the powder is discharged through the hopper 100 are shown in the figure.

Referring to the experimental results shown in FIG. 7, the horizontal axis (TD position) indicates the positions of the discharge port in the direction parallel to the axis of the roller, and the vertical axis (Density) indicates the density of the powder discharged at that position.

According to the experimental results, the graph shown in a square represents a general hopper with a conventional 90° inclined surface, and the powder density tends to decrease significantly at the edges of the discharge port (positions 1 and 8) compared to the center. This indicates that the frictional force with the inner wall of the hopper acts asymmetrically, causing a large difference in discharge speed and powder density between the center and the edges.

On the other hand, the graph shown as a triangle shows the experimental results when both the reverse-inclined portion (preferably 98° outer angle) and the separation plate are applied according to the embodiment of the present disclosure. In this case, the results showed that the powder density was maintained uniformly throughout the entire area of the discharge port. In particular, it can be seen that the density difference between the center and the edges was significantly reduced. This may be interpreted as a result of the stabilization of the powder flow by the separation plate and the reverse-inclined portion distributing the frictional force between the inner wall and the center of the hopper more evenly.

In addition, the triangular curve shows that the density of the powder is generally higher than in the conventional hopper. This indicates that the design of the present disclosure is optimized to minimize the loss during the powder discharge process and to achieve discharge at a uniform density.

In conclusion, FIG. 7 provides experimental evidence that the hopper according to the embodiment of the present disclosure can effectively improve the discharge uniformity and density of the powder compared to the conventional structure.

As described above, the hopper according to the embodiment of the present disclosure may control the flow of the powder and achieve uniformity of discharge through various structural elements such as the body, the inclined passage, the separation plate, and the air slit. The reverse-inclined portion of the body evenly distributes the frictional force with the inner wall, and the separation plate reduces the density difference between the center and the edge to stabilize the discharge speed of the powder.

In addition, the air slit and the air inlet form an air curtain to prevent the external leakage of the powder and control the discharge direction of the powder. In this configuration, the hopper according to the present disclosure may overcome the limitations of the conventional structure and may maintain uniform discharge and stable flow of the powder, thereby improving the efficiency of the production process.

As is apparent from the above description, according to an embodiment of the present disclosure, it is possible to uniformly discharge powder by improving a container structure of a hopper.

In addition, it is possible to prevent the leakage of powder to the outside using an air slit.

Moreover, it is possible to efficiently disperse the frictional force between the powder and an inner wall by disposing a separation plate in the hopper. The improvement may increase supply efficiency and quality in a manufacturing process.

Further scope of applicability of the present disclosure will be apparent from the above detailed description. However, various changes and modifications within the spirit and scope of the present disclosure should be clearly understood by those skilled in the art, and therefore the detailed description and specific embodiments, such as preferred embodiments of the present disclosure, should be understood as merely examples.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A hopper comprising:
a body having a hollow structure that is open at a top and bottom, the body being configured to store powder; and
an inclined passage connected to a lower end of the body, the inclined passage extending downward while gradually narrowing, wherein
the body comprises a reverse-inclined portion having a structure that gradually widens toward a lower end.

2. The hopper according to claim 1, wherein
the body further comprises a straight portion connected to an upper end of the reverse-inclined portion, the straight portion extending upward.

3. The hopper according to claim 1, wherein the reverse-inclined portion comprises at least one inner surface perpendicular to the ground.

4. The hopper according to claim 1, further comprising a separation plate located in the body so as to be perpendicular to the ground, the separation plate being configured to partition an interior of the body.

5. The hopper according to claim 4, wherein the body comprises a guide recess formed in a side surface thereof, the guide recess being configured to receive the separation plate.

6. The hopper according to claim 4, wherein at least a part of a side of the separation plate, which is substantially perpendicular to the ground, is spaced apart from an inner surface of the body.

7. The hopper according to claim 4, wherein the separating plate is made of a material that does not react with the powder.

8. The hopper according to claim 1, wherein the body comprises an air inlet formed in an outer surface thereof, the air inlet being configured to allow compressed air to be supplied from the outside.

9. The hopper according to claim 8, further comprising an air slit located at a side surface of the inclined passage, the air slit being connected to the air inlet, the air slit being configured to allow the supplied compressed air to pass therethrough in a direction toward a ground.

10. A powder supply apparatus comprising:
the hopper according to claim 1; and
a calendaring roller disposed beneath the hopper.

11. The powder supply apparatus according to claim 10, wherein the side surface of the inclined passage has a shape corresponding to a surface of the calendering roller.
